(19) United States
(12) Patent Application Publication
(10) Pub. No.: US 2004/0069653 A1
(43) Pub. Date: Apr. 15, 2004

(54) Electrochemical reduction of reducible dyes

(76) Inventors: Claudia Merk, Furstenfeldbruck (DE); Jorg Botzem, Limburgerhof (DE); Gunther Huber, Ludwigshafen (DE); Norbert Grund Ludwigshafen, Ludwigshafen (DE)

Correspondence Address: CONNOLLY BOVE LODGE & HUTZ, LLP, P O BOX 2207, WILMINGTON, DE, 19899, US

(21) Appl. No.: 10/673,840

(22) Filed: Sep. 29, 2003

Related U.S. Application Data
(63) Continuation of application No. 10/149,727, filed on Nov. 13, 2002, now abandoned.
Application No. 10/149,727 is a 371 of international application No. PCT/EP00/13103, filed on Dec. 21, 2000.

(30) Foreign Application Priority Data
Dec. 22, 1999 (DE) 19962155.1

(51) Int. Cl. C02F 1/461

(52) U.S. Cl. 205/688; 205/742

(57) ABSTRACT

A process for an electrochemical reduction of a reducible dye by contacting said reducible dye with a cathode comprising a support of an electrically conductive material and an electrically conductive, cathodically polarized layer formed thereon in situ by alluviation comprises conducting said electrochemical reduction in the presence of a base.

The present invention relates to a process for electochemical reduction of reducible dyes.

The electrochemical reduction of organic compounds in the presence of a cathode comprising a support of an electrically conductive material and an electrically conductive, cathodically polarized layer formed thereon in situ by alluviation is described in EP-A 0 808 920. Also see this reference for a discussion of the background art to electrochemical reductions of organic compounds. It also mentions the possibility of using the process described therein for reducing indigo to leucoindigo, describes the use of Pd/C, Pt/C, Rh/C and Ru/C as materials for forming the cathodically polarized layer, and proposes that the above reaction be carried out in an acidic medium. However, this will furnish only minor yields of leucoindigo.

EP-B 0 426 832 describes a process for reducing dyes whereby, inter alia, the sparingly soluble indigo can be converted into the soluble leuco form by reduction. The reduction in this process is carried out in an aqueous solution having a pH >9 using a reducing agent that has a redox potential of above 400 mV and that is present as a solute in reduced and oxidized form. This reducing agent is further characterized in that its redox potential (half-wave potential), increased by the charge transfer overvoltage to return the oxidized form of the reducing agent into the reduced form at the cathode, is below the cathode potential. Typically, in this reference, an indirect electrolysis is carried out in the presence of a mediator, for example iron(III) triethanolamine. The iron(III) triethanolamine is reduced at the cathode to iron(II) triethanolamine and in turn reduces indigo to leucoindigo. Iron(III) triethanolamine is re-formed in the process and then in turn reduced and regenerated at the cathode.

DE-A 198 312 91.1 discloses reducing indigo with hydrogen over Raney nickel.

It is an object of the present invention to provide a process for reducing vat dyes in high yield without the use of a mediator.

We have found that this object is achieved by the process of the invention.

The present invention accordingly provides a process for an electrochemical reduction of a reducible dye by contacting said reducible dye with a cathode comprising a support of an electrically conductive material and an electrically conductive, cathodically polarized layer formed thereon in situ by alluviation, which comprises conducting said electrochemical reduction in the presence of a base.

In the process of the invention, the catalytically active electrode is stabilized in the operational state by the pressure drop across the electrically conductive, cathodically polarized layer formed by alluviation. In this connection, the term “in situ” used herein comprehends all variants of such an alluviation of the material for the cathodically polarized layer, ie. before, together with or else after the introduction of the vat dye into the reactor. The term “in situ” thus means that the cathode is formed in the reduction cell, by alluviation. For regeneration purposes, the catalytically active electrode can be resuspended by reversing the flow and removed, for example by filtration or suction. Thus, the vat dyes are reduced using a system capable of forming and dismantling a catalytically active electrode within the process, merely requiring interventions already established within the operational practice of a chemical plant, such as the switching of pumps and actuators.

The support for the electrically conductive, cathodically polarized layer comprises electrically conductive materials. These include for example materials such as stainless steel, plain steel, nickel, nickel alloys, tantalum, platinized tantalum, titanium, platinized titanium, graphite, electrode carbon and similar materials and also mixtures thereof.

The support is preferably present as a permeably porous material, ie. the support has pores. These may be woven, in the form of commercially available filter fabrics, from metal wires or carbon fibers. Common examples include filter fabrics constructed with a plain weave, a twill weave, a twilled Dutch weave, a plain Dutch weave and a satin weave. It is also possible to employ foraminous metal foils, metal felts, graphite felts, edge filters, screens or porous sintered bodies as large-area supports in the form of plates or candles. The pore size of the support is generally from 5 to 300 μm, preferably from 50 to 200 μm. The support should always be designed so as to provide a very large open area, so that the pressure drops to be overcome in carrying out the process according to the invention are only minor. Supports that are particularly useful for the present process customarily have an open area of preferably at least about 10%, more preferably at least about 20%, and especially about 50%, the open area being at most about 70%.

The electrically conductive material for the electrically conductive, cathodically polarized layer can be any electrically conductive material, provided it can be formed into a layer by alluviation against the above-defined support.

The cathodically polarized layer preferably includes a metal, a conductive metal oxide or a carbonaceous material, for example carbon, especially activated carbon, carbon blacks or graphites, or a mixture of two or more thereof.

Useful metals include preferably all classic hydrogenation metals, especially the metals of the Ist,. IInd and VIIIth transition group of the Periodic Table of the. Elements, especially Co, Ni, Fe, Ru, Rh, Re, Pd, Pt, Os, Ir, Ag, Cu, Zn, Pb and Cd. Ni, Co, Ag, Fe and Cu are preferably used as Raney nickel, Raney cobalt, Raney silver, Raney copper and Raney iron, any of which may be doped with foreign metals such as Mo, Cr, Au, Mn, Hg, Sn or other elements of the Periodic Table, especially S, Se, Te, Ge, Ga, P, Pb, As, Bi and Sb.

The metals used according to the invention are preferably present in finely divided and/or activated form.

It is further possible to use conductive metal oxides, for example magnetite.

The cathodically polarized layer may also be formed solely by alluviation of the above-defined carbonaceous material.

In addition, the cathode can be constructed in situ by alluviating the abovementioned metals and conductive oxides, each on carbonaceous materials, especially activated carbon, on the support.

The present invention accordingly also provides a process of the type in question wherein said cathodically polarized layer includes a metal or a conductive metal oxide or a mixture of two or more thereof, each on activated carbon.

Layers particularly worth mentioning are layers including Pd/C, Pt/C, Ag/C, Ru/C, Re/C, Rh/C, Ir/C, Os/C and Cu/C, which may each in turn be doped by foreign metals or other elements of the Periodic Table, preferably S, Se, Te, Ge, Ga, P, Pb, As, Bi and Sb.

In addition, the abovementioned metals alluviated against the support may be in the form of nanoclusters, prepared for example as described in DE-A-44 08.512, on surfaces such as, for example, metals and carbonaceous materials.

In a further preferred embodiment, the cathodically polarized layer comprises the dye to be reduced. This layer may further comprise a metal, a conductive metal oxide or a carbonaceous metal or a mixture of two or more thereof and the dye to be reduced.

In addition, the cathodically polarized layer may include an electrically conductive assistant to improve the adhesion of the above-defined metals, metal oxides or nanoclusters to the support or to enlarge the surface area of the cathode, suitable examples being electrically conductive oxides such as magnetites and carbon, especially activated carbon, carbon blacks, carbon fiber and graphites.

In a further embodiment of the present process, the cathode used is obtained by the electrically conductive assistant first being alluviated onto the support and this assistant subsequently being doped in situ with metals by reduction of salts of metals of the Ist, IInd and/or VIIIth transition group at the coated electrode. The salts used of the abovementioned metals are preferably metal halides, phosphates, sulfates, chlorides, carbonates, nitrates and also the metal salts of organic acids, preferably formates, acetates, propionates or benzoates, particularly preferably acetates.

The cathode used according to the invention is constructed in situ by the abovementioned metals or metal oxides being alluviated against the support directly or after the electrically conductive assistant has been applied.

The average size of the particles forming the above-defined layer and the layer thickness are always chosen so as to ensure an optimum ratio of filter pressure drop and hydraulic throughput and permit optimum mass transfer. The average particle size is generally from about 1 to about 400 μm, preferably from about 30 to about 150 μm, while the layer thickness is generally from about 0.05 mm to about 20 mm, preferably from about 0.1 to about 5 mm.

It is to be noted in this connection that, in the process according to the invention, the pore size of the support generally exceeds the average diameter of the particles forming the layer, so that two or more particles will form bridges across the interstices while the layer is being formed on the support, this having the advantage that the formation of the layer on this support does not result in any significant obstruction of the flow for the suspension/solution containing the dye to be reduced. Preferably the pore size of the support is from about twice to about four times as large as the average size of the particles forming the layer. It will be appreciated that for the purposes of the present invention it is also possible to use supports having pore sizes that are smaller than the average size of the particles forming the layer, although in that case a very close watch must be kept on the extent to which the flow is obstructed by the layer being formed.

The cathode used in the invention, formed in situ by the constituents that form the layer being alluviated against the electrically conductive support, preferably includes for the inventive reduction of reducible dyes the particular dye to be reduced, which has a sparing solubility, as well as the cathodically polarized electroconductive material. The alluviated layer can at certain time intervals be dealluviated again in order that better mixing of the dye to be reduced and the electrically conductive material may be obtained. Mixing is followed by realluviation. This operation may be repeated as often as desired during any reduction.

In addition, the cathode of the invention may be formed here too from the electrically conductive support and a filter layer formed in situ from the particular dye by alluviation.

After the reduction has ended or when the catalytically active layer is spent, it can be separated from the support, simply by reversing the direction of flow, and can be disposed of or regenerated independently of the reduction. After the spent layer has been completely removed from the system, it is then possible once more to recoat the support with the particles forming the layer and, after said particles have been completely alluviated, to continue the reduction of the dye to be reduced.

The current densities within the process according to the invention generally range from about 50 to about 10 000 A/m², preferably from about 1 000 to about 4 000 A/m².

The throughput of the solution containing the dyes to be reduced ranges in general from about 1 to about 4 000 m³/(m²×h), preferably from about 50 to about 1 000 m³/(m²×h). For a system pressure of generally from about 1×10⁴ Pa (absolute) to about 4×10⁶ Pa, preferably from about 4×10⁴ Pa to about 1×10⁶ Pa, the pressure drop in the layer at the throughputs used according to the invention ranges from about 1×10⁴ Pa to about 2×10⁵ Pa, preferably from about 2.5×10⁴ Pa to about 7.5×10⁴ Pa.

The process according to the invention is generally carried out at from about 0° C. to 100° C., preferably at from about 40° C. to about 80° C.

The process according to the invention is carried out in an alkaline medium, ie. at a pH of above 7, preferably at a pH from 9 to 14, especially at a pH from 12 to 14. The alkaline pH can be set in principle using any base suitable for the purpose. Preference is given to using alkali metal and alkaline earth metal hydroxides, carbonates, bicarbonates and alkoxides, for example the corresponding methoxides, ethoxides, butoxides and isopropoxides, more preferably aqueous sodium hydroxide solution or aqueous potassium hydroxide solution. It is also possible to use mixtures of two or more thereof.

Particularly preferably the reaction is carried out at normal pressure and at the temperatures mentioned.

Within the framework of the process according to the invention, the sort of cell type used, the shape and the arrangement of the electrodes do not have any decisive influence, so that it is in principle possible to use any of the cell types customary in electrochemistry.

The two following apparatus variants may be mentioned by way of example:

a) Undivided cells

Undivided cells with a plane-parallel electrode arrangement or candle-shaped electrodes are preferably used in those cases where neither the reactants nor the products are adversely affected by the anode process or react with one another. The electrodes are preferably disposed in a plane-parallel arrangement, since this embodiment combines a narrow interelectrode gap (from 1 mm to 10 mm, preferably 3 mm) with a homogeneous current distribution. Preferably the edge gap element is composed of stainless steel, platinum, platinized niobium, titanium, tantalum or nickel.

b) Divided cells

Divided cells with a plane-parallel electrode arrangement or candle-shaped electrodes are preferably used in those cases where the catholyte has to be separated from the anolyte, for example to preclude secondary chemical reactions or to simplify the subsequent separation of materials. The separating medium used may be ion exchange membranes, microporous membranes, diaphragms, filter fabrics made of materials that do not conduct electrons, sintered glass discs and also porous ceramics. Preference is given to using ion exchange membranes, especially cation exchange membranes, of which in turn the use is preferred of those membranes that comprise a copolymer of tetrafluoroethylene and a perfluorinated monomer containing sulfo groups. The electrodes are preferably disposed in a plane-parallel arrangement in divided cells too, since this embodiment combines narrow interelecttode gaps (two gaps each from 0 mm to 10 mm, preferably 0 mm anodic and 3 mm cathodic) with a homogeneous current distribution. Preferably the separating medium bears directly against the anode.

The feature common to both apparatus variants is the design of the anode. Useful electrode materials include in general perforated materials, such as nets, expanded metal sheets, lamellae, profiled webs, grids and smooth metal sheets. A plane-parallel electrode arrangement takes the form of planar sheets and the embodiment involving candle-shaped electrodes takes the form of a cylindrical arrangement.

The choice of the anode material or of its coating is dependent on the anolyte solvent. For instance, graphite electrodes are preferred for use in organic systems while materials or coatings having a low oxygen overpotential are preferred for use in aqueous systems. Examples of acidic anolytes are titanium or tantalum supports with electrically conductive interlayers to which are applied electrically conductive mixed oxides of the IVth to VIth transition group which are doped with metals or metal oxides of the platinum group. In the case of basic anolytes, iron or nickel anodes are preferred.

Useful solvents include water or its mixture with amines, alcohols, DMF, DMSO, HMPT, DMPU and other polar solvents.

The reduction according to the invention is generally carried out in the presence of an ancillary electrolyte. It is added to adjust the conductivity of the electrolysis solution and/or to control the selectivity of the reaction. The electrolyte content is typically equivalent to a concentration of from about 0.1 to about 10%, preferably from about 1 to about 5%, by weight, based on the reaction mixture. Useful ancillary electrolytes include neutral salts. Useful cations include metal cations of lithium, sodium, potassium, but also tetraalkylammonium cations, eg. tetramethylammoniur, tetraethylammonium, tetrabutylammonium and dibutyldimethylammonium. Useful anions are fluoride, tetrafluoroborate, sulfonates, eg. methanesulfonate, benzenesulfonate, toluenesulfonate, sulfates, eg. sulfate, methylsulfate, ethylsulfate, phosphates, eg. methylphosphate, ethylphosphate, dimethylphosphate, diphenylphosphate, hexafluorophosphate, phosphonates, eg. methyl methylphosphonate and methyl phenylphosphonate.

Also suitable, when organic cosolvents are used, are alkaline compounds, for example alkali metal or alkaline earth metal hydroxides, carbonates, bicarbonates and alkoxides, preference among alkoxide anions being given to methoxide, ethoxide, butoxide and isopropoxide.

Useful cations in these alkaline compounds again include the abovementioned cations.

The electrochemical reduction of the invention can be carried out either continuously or batchwise. In either case, the cathode is first prepared in situ by a catalytically active layer being formed on the support by alluviation. To this end, perfusion of the support by a suspension of the finely divided metal and/or of the conductive metal oxide and/or of the nanocluster and/or of the carbonaceous material, ie. the material to be alluviated, is conducted until essentially the entire amount of the material in the suspension is located on the support. Whether this is the case can be observed visually, for example from the fact that the suspension, which is cloudy at the start of alluviation, becomes clear.

When additionally an interlayer is to be alluviated, the support is perfused by a suspension of the material forming the interlayer until essentially the entire amount used is located on the support. This is followed by the above-described procedure for alluviating the material which forms the cathodically polarized layer.

When an interlayer is used, there is the additional option of perfusing the support, provided with an interlayer, with a solution or suspension of a metal salt of a metal with which the support layer is to be doped, and of reducing, by applying a suitable voltage to the cell, the metal cations present in this solution or suspension in situ at the cathode.

On completion of the preparation of the cathode the dye to be reduced is supplied to the system and is reduced by a previously precisely defined quantity of electricity being introduced into the system. Accurate control of the supplied quantity of electricity makes it possible within the framework of the process according to the invention to isolate even partially reduced compounds.

In the case of complete reduction of the reactant dyes, the selectivities will be at least 70%, generally above 80%, and in the case of particularly smooth reductions they will be above 95%.

In the course of the prepared product being isolated any spent catalyst may be replaced by the direction of flow being reversed in the electrolytic cell, so that the alluviated layer loses contact with the support and the catalyst can be removed, for example by aspiration or filtration of the suspension containing it.

Thereafter, the layer can be constructed once more as described above, and then new reactant supplied and converted.

Furthermore, the steps of conversion (reduction), renewal of the catalyst and renewed conversion (reduction) can also be carried out alternately by the cathode first being prepared in situ by alluviation as described above, the dye to be reduced then being supplied and converted, the flow direction within the electrolytic cell being changed after conversion has ended and the spent catalyst being removed, for example by filtration, the cathode then again being built up with fresh material forming the cathodically polarized layer and this being followed by further reduction.

It will be appreciated that this alternation between conversion, removal of the spent layer and renewal of the cathode can be repeated any number of times, as a result of which the process according to the invention can be carried out not only batchwise but also continuously, which leads in particular to extremely short downtimes during catalyst regeneration or replacement.

In a further preferred embodiment of the process according to the invention, the electrolytic unit comprising at least one cathode with a shared catholyte circuit is operated in a steady state as a homogeneously continuous reactor. This means that, after the catalyst has been alluviated once, a defined concentration level of reactants and products is maintained. To this end the reaction solution is continuously recirculated through the electrochemically active cathode and the circuit is continuously supplied with reactant, product being withdrawn off continuously from this circuit, so that the reactor contents remain constant over time.

The reactant is continuously metered in in the form of a solid, which is alluviated, so that the solution receiving the dissolved product can be continuously discharged.

The advantage of this form of process operation compared to batch operation is the simplicity of using less equipment.

The reaction drawback—that either concentrations are unfavorable (ie. low reactant concentration and high product concentrations at the endpoint of the reaction) or more separation is needed at workup—can be remedied using the following apparatus configuration, which is particularly preferred:

At least two electrolytic units are connected in series, the reactant being supplied to the first unit and the product being withdrawn from the last unit. This procedure ensures that the first electrolytic unit(s) is(are) operated at distinctly more favorable concentration profiles than the last unit(s). This means that, averaged over all the electrolytic units, higher space-time yields are provided than with the electrolytic units operated in parallel.

This battery arrangement of the electrolytic units is particularly advantageous in those cases where the production capacity demanded in any case requires the installation of a plurality of electrolytic units.

The process of the invention can in principle reduce all reducible dyes. The reducible dyes can be selected from a group consisting of vat dyes and sulfur dyes. Vat dyes for the purposes of the present invention are in particular indigo and other indigoid dyes, anthraquinonoid dyes, and leuco vat dye esters.

Useful reducible dyes include in particular sulfur dyes. For further details regarding such dyes see Römpp Chemielexikon, CD version 1.0, Stuttgart/New York: Georg Thieme Verlag 1995 under the headwords of “Indigo”, “Küpenfarberei”, “Küpenfarbstoffe”, “Indanthren-Farbstoffe”, Ullmann CD version 1999, 6^{th} edition, Verlag Wiley-VCH, English version under the headwords “Anthraquinone Dyes and Intermediates”.

Suitable are in particular the following dyes, some of which are accessible via the Colour Index, 3^{rd} Edition, Vol. 3, The Society of Dyers and Colourists, American Association of Textile Chemists and Colorists, 1971, p. 37179-3844 or 3^{rd} Edition, 3^{rd} Revision, Vol. 5, 1987, p. 8227-8234, 3^{rd} edition (1971), p. 3649-3704, issue of 1987, p. 5179-87, p. 5305-532 and p. 5292-5302), the cited pages of the Colour Index including further compounds and being fully incorporated herein.

Specific examples are: indigo, 5,5′-dibromoindigo, 5,5′,7,7′-tetrabromoindigo, thioindigo, flavanthrene, violanthrene and also the following classes of compounds recited in the cited Ullmann passage:

acylaminoanthraquinones, anthraquinoneazoles, anthrimides and other branched anthraquinones, anthrimidecarbazoles, phthaloylacridones, benzanthrone dyes, inanthrones and highly fused ring systems, for example dibenzopyrenequinone, anthanthrone and pyranthrone.

The inventive process for reducing dyes has in particular the following advantages:

1. because the reaction is carried out in alkaline solution, the corresponding reduced target compound is obtained in high yield with high selectivity;

2. the present process electrochemically reduces the reactant dye directly at the cathode, obviating the need for a mediator.

The present invention further provides for the use of an electrochemically reduced reducible dye that has been prepared according to the invention for dyeing objects.

In the context of the present invention the term “objects” in principle comprehends all objects that can be dyed, colored, stained, etc. with the dye of the invention. This includes not only wovens, loop-drawn knits and loop-formed knits from natural or synthetic fibers but also wood, plastic, glass and metal objects. Skin and tissue can also be stained.

The present invention will now be more particularly described with reference to examples.

### EXAMPLES

1. Examples of electrochemical reduction of reducible dyes

### Comparative Example

The example hereinbelow, which relates to the reduction of indigo to leucoindigo in an acidic medium, and the subsequent example were carried out in the following apparatus:

| | |
|---|---|
| Electrolytic cell: | divided electrolytic cell of |
| | the flowthrough type |
| Membrane: | Nafion-324 |
| Anode: | DeNora DSA (anode area: |
| | 100 cm²) |
| Cathode: | reverse plain Dutch weave of |
| | stainless steel material |
| | No. 1.4571 (cathode area: |
| | 100 cm², pore size: 50 μm) |
| Flow rate: | about 20 1/h through the |
| | cathode. |

1 200 g of 2% sulfuric acid were used as anolyte.

The catholyte was a mixture of 1 344 g of H₂O, 28 g of H₂SO₄ (96%), 28 g of indigo granules and 10 g of Pd/C; 10% Pd content and 10 g of BA 1200 (from Anton Richard KG of Gräfelfing).

The reaction was carried out as follows:

First the two cell compartments were filled and the catholyte was heated to 60° C. Then the catalyst and the graphite components mixed with indigo were alluviated onto the abovementioned cathode in the course of 15 minutes. The electrolysis was then carried out at 60° C. and a current density of 50 mA/cm². The run was terminated after 12 F. The solution was discharged under a nitrogen stream, filtered to remove the catalyst, adjusted to an alkaline pH (pH 13) with aqueous sodium hydroxide solution and oxidized up with air to determine the amount of indigo converted.

Analysis revealed 0.4 g of electrochemically reduced indigo, which corresponds to a yield of 1.4%.

### Inventive Example

The anolyte used was 1 200 g of 2% sulfuric acid. The catholyte was a mixture of 1 344 g of water, 28 g of sodium hydroxide, 28 g of indigo granules, 10 g of Pd/C (10%; BASF E-101, R/D), 10 g of Sigradur K (20-50 μm) and 10 g of BA 1200.

First the two cell compartments were filled and the catholyte was heated to 60° C. Then the catalyst and the graphite components mixed with indigo were alluviated onto the abovementioned cathode in the course of 15 minutes. The electrolysis was then carried out at 60° C. and a current density of 50 mA/cm². The run was terminated after 5 F. The solution was discharged under a nitrogen stream, filtered to remove the catalyst, adjusted to an alkaline pH (pH 13) with aqueous sodium hydroxide solution and oxidized up with air to determine the amount of indigo converted.

Analysis revealed 22.4 g of electrochemically reduced indigo, which corresponds to a yield of 80%.

2. Dyeing Example

10 g of ecru (Nm 12) cotton yarn were dyed with the leucoindigo solution produced in the inventive preparative example (but not air oxidized) on an indigo lab dyeing machine (from Looptex, Lugano, Switzerland) that is suitable for dyeing cotton yarn by the sheet dyeing process and by the rope dyeing process.

The procedure used was as follows:

The ecru cotton yarn was initially prewetted in 2 l of a cold wetting agent liquor containing 3 g/l of a commercially available wetting agent (Primasol NF; BASF), squeezed off to 75% wet pickup and dipped into the hereinbelow described dyebath (amount made up=2 l) which had been adjusted to pH 11.5. After 15 sec immersion and squeezing off to 70% wet pickup, the yarn was air oxidized at room temperature for 120 sec. This operation was repeated 6 times. The dyed yarn was then rinsed with deionized water and subsequently dried.

The dyebath adjusted to pH 11.5 had the following composition:

| | |
|---|---|
| 6 ml/l | of 38° Be aqueous sodium hydroxide solution |
| | (3.9 g/l of 50% aqueous sodium hydroxide |
| | solution) |
| 3 g/l | of a commercially available wetting agent |
| | (Primasol NF; BASF) |
| 3 g/l | of sodium dithionite (Hydrosulfit konz.; BASF) |
| 250 g/l | of the leucoindigo solution specified in the |
| | inventive preparative example. |

The dyeing obtained was equivalent with regard to depth of shade and penetration to the indigo dyeings prepared at the same pH in the examples of WO 94/23114, which were obtained with indigo or conventionally prepared leucoindigo.

We claim:

1. A process for an electrochemical reduction of a reducible dye by contacting said reducible dye with a cathode comprising a support of an electrically conductive material and an electrically conductive, cathodically polarized layer formed thereon in situ by alluviation, which comprises conducting said electrochemical reduction in the presence of a base.

2. A process as claimed in claim 1, wherein said cathodically polarized layer comprises said reducible dye.

3. A process as claimed in claim 1, wherein said cathodically polarized layer includes a metal, a conductive metal oxide or a carbonaceous material or a mixture of two or more thereof.

4. A process as claimed in any of claims 1 to 3, wherein said cathodically polarized layer includes a metal, a conductive metal oxide or a carbonaceous material or a mixture of two or more thereof and of said dye to be reduced.

5. A process as claimed in any of claims 1 to 4, wherein said cathodically polarized layer comprises a metal of the Ist, IInd or VIIIth transition group of the Periodic Table of the Elements, in each case as a free metal or as a conductive metal oxide, or a mixture of two or more thereof.

6. A process as claimed in any of claims 1 to 5, wherein said cathodically polarized layer includes a metal or a conductive metal oxide or a mixture of two or more thereof, each on activated carbon.

7. A process as claimed in any of claims 1 to 5, wherein said cathodically polarized layer includes Raney nickel, Raney cobalt, Raney silver, Raney iron or Raney copper.

8. A process as claimed in any of claims 1 to 7, wherein said support of electrically conductive material is porous.

9. A process as claimed in any of claims 1 to 8, wherein said reducible dye is selected from the group consisting of vat dyes and sulfur dyes.

10. A process as claimed in claim 9, wherein said vat dye is selected from the group consisting of indigo, indigoid dyes, anthraquinonoid dyes, phthalocyanine dyes, naphthalene dyes, Immedial dyes and leuco vat dye esters and also mixtures of two or more thereof.

11. A process as claimed in any of claims 1 to 10, wherein said base is selected from the group consisting of alkali metal and alkaline earth metal hydroxides, carbonates, bicarbonates and alkoxides and also mixtures of two or more thereof.

12. The method of using an electrochemically reduced reducible dye prepared according to a process as claimed in any of claims 1 to 11 for coloring objects.
